(19) United States
(12) Patent Application Publication
(10) Pub. No.: US 2012/0062556 A1
(43) Pub. Date: Mar. 15, 2012

(54) THREE-DIMENSIONAL IMAGE DISPLAY APPARATUS, THREE-DIMENSIONAL IMAGE PROCESSOR, THREE-DIMENSIONAL IMAGE DISPLAY METHOD, AND COMPUTER PROGRAM PRODUCT

(76) Inventors: Sumihiko Yamamoto, Tokyo (JP); Rieko Fukushima, Tokyo (JP); Yuzo Hirayama, Kanagawa (JP)

(21) Appl. No.: 13/214,664

(22) Filed: Aug. 22, 2011

(30) Foreign Application Priority Data
Sep. 13, 2010 (JP) 2010-204762

(51) Int. Cl. G06T 15/00

(52) U.S. Cl. 345/419

(57) ABSTRACT

According to an embodiment, a three-dimensional image display apparatus includes a display unit; a detecting unit configured to detect an observation position of an observer relative to the display unit; a determining unit configured to determine an amount of parallax of an input image signal to be reduced as an angle increases between a normal direction of a surface of the display unit and an observation direction based on the detected observation position or as a distance decreases between the surface of the display unit and the detected observation position; and a generating unit configured to generate a multi-view image to be displayed on the display unit on the basis of the determined amount of parallax.

### CROSS-REFERENCE TO RELATED APPLICATION(S)

This application is based upon and claims the benefit of priority from Japanese Patent Application No. 2010-204762, filed on Sep. 13, 2010; the entire contents of which are incorporated herein by reference.

### FIELD

Embodiments described herein relate generally to a three-dimensional image display technique.

### BACKGROUND

In recent years, at a movie theater, a way of viewing a three-dimensional image has been spread in which the observer wears glasses and views different images (parallax images) with the left and right eyes at corresponding positions. In addition, as a glasses-free three-dimensional image display technique, a technique has been proposed in which a parallax barrier, such as pinholes, slits, or a lens array, is provided on the display surface of a flat panel display (FPD) and the sub-pixels viewed by the observer are changed according to an observation position so as to allow the observer to recognize parallax information corresponding to the observation position of the observer or the positions of the left and right eyes of the observer.

In the above-mentioned techniques, when there is a large parallax, the observer perceives the depth of an image such that objects seem to burst out from the screen, and at other times, objects seem to reach deep behind the screen. When there is no parallax, the observer perceives the image of an object as a planar image.

As a technique for displaying a high-reality three-dimensional image, there is a technique for enabling the observer to view the side of an object by using motion parallax that results from movement of the observation position of the observer.

In the three-dimensional image display technique, it is desirable to display a high-quality three-dimensional image regardless of the observation position of the user.

### BRIEF DESCRIPTION OF THE DRAWINGS

FIG. 1 is a diagram illustrating the structure of a three-dimensional image display apparatus according to a first embodiment;

FIG. 2 is a diagram illustrating the structure of a display unit;

FIG. 3 is a diagram illustrating the display state of a three-dimensional image by the three-dimensional image display apparatus;

FIG. 4 is a diagram illustrating the display state of a three-dimensional image by the three-dimensional image display apparatus;

FIG. 5 is a diagram illustrating the display state of a three-dimensional image by a glasses-type three-dimensional image display apparatus;

FIG. 6 is a diagram illustrating the function of an observation position detecting unit;

FIG. 7 is a diagram illustrating a phenomenon in which a display surface is recognized to be narrow;

FIG. 8 is a graph illustrating the relationship between an observation angle and the width of appearance;

FIG. 9 is a diagram illustrating a reduction in visual range width;

FIG. 10 is a graph illustrating the relationship between the observation angle and the visual range angle;

FIG. 11 is a diagram illustrating a reduction in visual distance;

FIG. 12 is a graph illustrating the relationship between the observation angle and the visual range width;

FIG. 13 is a graph illustrating the relationship between the observation angle and the amount of crosstalk;

FIG. 14 is a graph illustrating the relationship between the observation angle and depth in the first embodiment;

FIG. 15 is a diagram illustrating the relationship between parameters;

FIG. 16 is a flowchart illustrating a three-dimensional image display process according to the first embodiment;

FIG. 17 is a diagram illustrating the structure of a three-dimensional image display apparatus according to a second embodiment;

FIG. 18 is a graph illustrating the relationship between an observation angle and depth in the second embodiment;

FIG. 19 is a diagram illustrating a planar image display region and a three-dimensional image display region;

FIG. 20 is a flowchart illustrating a three-dimensional image display process according to the second embodiment;

FIG. 21 is a graph illustrating the relationship between an observation angle and depth according to a first modification;

FIG. 22 is a flowchart illustrating a three-dimensional image display process according to the first modification;

FIG. 23 is a graph illustrating the relationship between an observation angle and depth according to a second modification; and

FIG. 24 is a flowchart illustrating a three-dimensional image display process according to the second modification.

### DETAILED DESCRIPTION

According to an embodiment, a three-dimensional image display apparatus includes a display unit; a detecting unit configured to detect an observation position of an observer relative to the display unit; a determining unit configured to determine an amount of parallax of an input image signal to be reduced as an angle increases between a normal direction of a surface of the display unit and an observation direction based on the detected observation position or as a distance decreases between the surface of the display unit and the detected observation position; and a generating unit configured to generate a multi-view image to be displayed on the display unit on the basis of the determined amount of parallax.

Various embodiments will be described hereinafter with reference to the accompanying drawings. The following embodiments explain a case where an alignment method for a pattern image formed on a reticle is used in an examination apparatus that detects presence or absence of defect of a pattern image formed on a reticle, as an example; however, the embodiments are not limited to this.

In the following embodiments, for convenience of explanation, a scale of each component is adjusted in order to have a recognizable size in the drawings, and the directions in the drawings, such as the vertical and horizontal directions, are relative and may be different from those based on the gravity direction.

In the following embodiments, an example of a three-dimensional image display apparatus that displays a three-dimensional image using a display method, which is called an integral imaging method (hereinafter, referred to as an II method) which naturally prevents flipping (the flipping of images) with a mass of beams using an array of lenticular lenses extended in the vertical direction, as the glasses-free method will be described. However, the invention is not limited to the II method, but can be applied to a glasses-type three-dimensional image display apparatus other than the glasses-free three-dimensional image display apparatus.

### First Embodiment

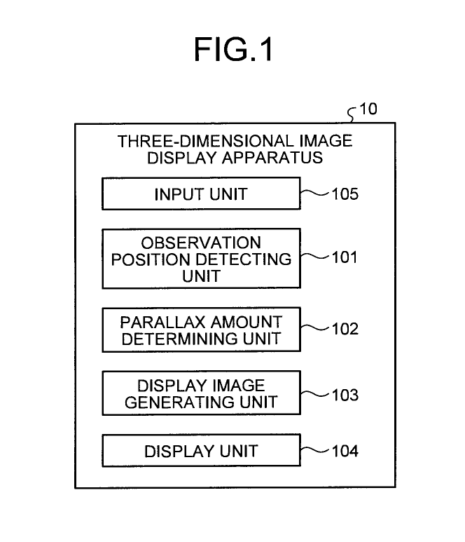

As shown in FIG. 1, a three-dimensional image display apparatus 10 according to a first embodiment mainly includes an input unit 105, an observation position detecting unit 101, a parallax amount determining unit 102, a display image generating unit 103, and a display unit 104. The three-dimensional image display apparatus 10 according to this embodiment receives a three-dimensional image to be displayed from an external image generating apparatus or an image reproducing apparatus and displays the three-dimensional image on the display unit 104 in real time.

The input unit 105 receives a multi-view image or a three-dimensional image signal from an image generating apparatus, such as a camera, or receives a three-dimensional image signal through a decoder of an image reproducing apparatus.

The observation position detecting unit 101 detects the observation position of the observer relative to the display unit 104. In this embodiment, an acceleration sensor that measures the angle of the three-dimensional image display apparatus 10 with respect to the gravity direction is provided and the observation angle of the observer with respect to the display unit 104 is detected as the observation position from the output of the acceleration sensor.

The observation position detecting unit 101 is not limited thereto. The observation position detecting unit 101 may be configured as follows: a head tracking sensor for estimating the direction of the face or head recognized using the image captured by a camera is provided in the three-dimensional image display apparatus 10 and the observation position detecting unit 101 detects, as the observation position, the observation angle of the observer with respect to the front surface of the display unit 104 from the output of the head tracking sensor. In addition, the observation position detecting unit 101 may be configured as follows: a distance sensor for measuring the distance between the observer and the display unit 104 is provided in the three-dimensional image display apparatus 10 and the distance of the observer from the display unit 104 is detected as the observation position from the output of the distance sensor.

The parallax amount determining unit 102 determines the amount of parallax of the parallax information of the three-dimensional image signal received by the input unit 105 to be reduced as an angle increases between a normal direction of a surface of the display unit 104 and an observation direction based on the observation position or as a distance decreases between the surface of the display unit 104 and the observation position, in order to generate an element image array to be displayed on the display unit 104 by the display image generating unit 103. In this embodiment, the parallax amount determining unit 102 determines the amount of parallax to be continuously reduced as the observation angle θ with respect to the front surface of the display unit 104, serving as the observation position, increases. Alternatively, the parallax amount determining unit 102 may determine the amount of parallax serving as the observation position to be reduced as the distance from the front surface of the display unit 104 is reduced. The parallax amount determining unit 102 will be described in detail below.

The element image means a set of parallax images displayed by sub-pixels corresponding to an exit pupil (aperture 116), which will be described below, and the element image array means an element image group displayed on the display unit 104.

The display image generating unit 103 generates the element image array (multi-view image) composed of the element images on the basis of the amount of parallax determined by the parallax amount determining unit 102 and displays the generated element image array on the display unit 104.

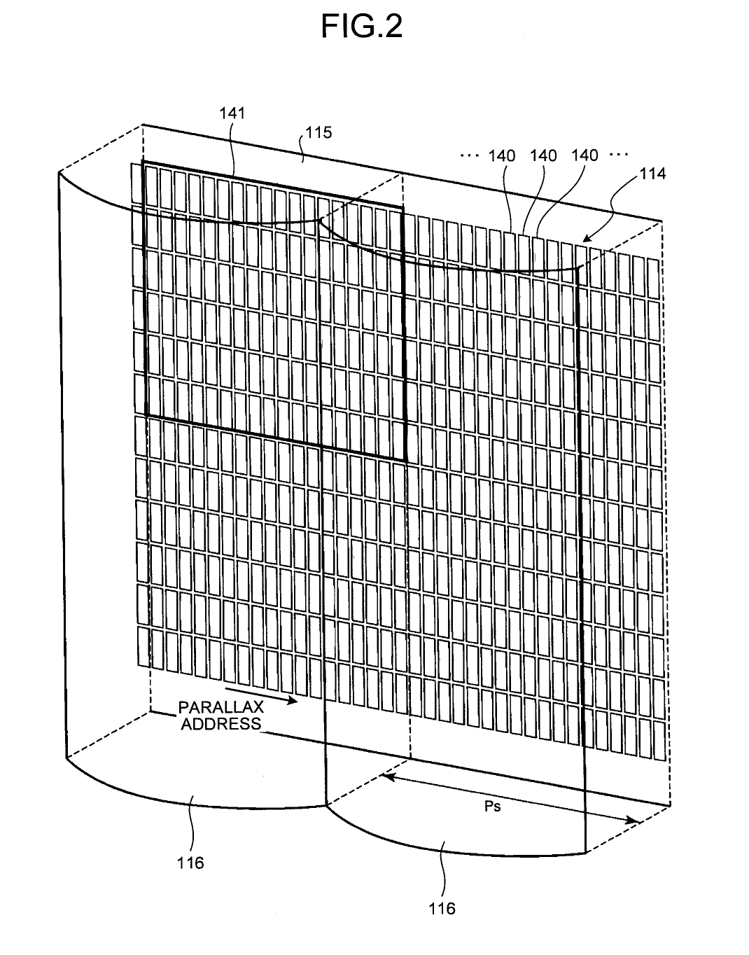

The display unit 104 is a device that displays the multi-view image generated by the display image generating unit 103. FIG. 2 is a perspective view schematically illustrating an example of the structure of the display unit 104 according to this embodiment. In FIG. 2, the number n of viewpoints is 18. As shown in FIG. 2, the display unit 104 includes a display element array 114 and an aperture control unit 115 that is provided on the front surface of the display element array 114. For example, an Liquid Crystal Display (LCD) may be used as the display element array 114.

The aperture control unit 115 is a beam control element that limits beams and emits the beams in a predetermined direction. As shown in FIG. 2, a lenticular sheet is used as the aperture control unit 115 according to this embodiment. The lenticular sheet is an array plate of lens segments that control incident and emission beams to be emitted in a predetermined direction. For example, an array plate, such as a slit in which a light transmission region is appropriately provided, may be used as the aperture control unit 115. The light transmission region and the lens segment have a function of selectively transmitting only the beams polarized in a specific direction among the beams emitted from the display element array 114 to the front side thereof. In the following description, the lens segment and the light transmission region are referred to collectively as an aperture.

For example, a lenticular sheet, which is an array plate of lenses having a generating line in a direction vertical to the screen of the display element array 114, is used as the aperture control unit 115. Each of the apertures 116 of the lens segment is arranged so as to correspond to the pixel. The aperture control unit 115 is not limited to the array plate having the lenticular segment and the light transmission region integrated with each other, but it may be an LCD serving as an optical shutter in which the position and shape of the light transmission region can be changed over time.

In the general FPD, one pixel includes R, G, and B sub-pixels. It is assumed that one display element corresponds to one sub-pixel. In the example shown in FIG. 2, each display element (sub-pixel 140) has an aspect ratio of 3:1 so that a pixel has a square shape. In the display element array 114, the display elements (sub-pixels 140) are arranged in a matrix. Each of the sub-pixels corresponds to any one of red (R), green (G), and blue (B). For the row direction, an image displayed in a pixel group in which the sub-pixels corresponding to the number of parallaxes are arranged in the row direction, that is, a group of parallax images displayed by the sub-pixels corresponding to the exit pupil (aperture 116) is referred to as the element image. The sub-pixels are not limited to the R, G, and B sub-pixels.

For the column direction, in the example shown in FIG. 2, a set of six sub-pixels arranged in the column direction is used to form an element image. That is, one element image 141 (which is represented by a frame in FIG. 2) is displayed by 18 sub-pixels in the row direction and 6 sub-pixels in the column direction. In FIG. 2, three-dimensional display that gives 18 parallaxes in the horizontal direction can be performed. In addition, since 6 pixels are arranged in the column direction, the element image, that is, the pixels for three-dimensional display have a square shape. The position of the pixel in the horizontal direction within one effective pixel corresponds to the aperture control unit 115 and is correlated with the emission angle of the beam. An address indicating the direction of the beam is referred to as a parallax address. The parallax address corresponds to the position of the pixel in the horizontal direction within one effective pixel. The parallax address increases toward the right direction of the screen.

The apertures 116 of the aperture control unit 115 are provided so as to correspond to the position of the element image. In the example shown in FIG. 2, the width (lens pitch) Ps of the aperture 116 is equal to the width of one element image.

In the above-mentioned structure, for example, a plurality of images acquired from the same object with a plurality of different parallaxes is supplied from an image generating apparatus, such as a camera, or a decoder of an image reproducing apparatus, to the input unit 105. The plurality of images is interleaved with the pixels at the corresponding positions and is supplied as one image data item. The embodiment is not limited thereto, but a plurality of image data may be individually supplied. The display image generating unit 103 distributes the sub-pixels that have different parallaxes and are disposed at positions corresponding to the supplied plurality of images in the order corresponding to the parallaxes. The display image generating unit 103 forms an element image using the distribution and supplies the element image to the display element array 114 of the display unit 104.

The aperture 116 of the aperture control unit 115 is an exit pupil that is provided so as to correspond to the element image 141 (hereinafter, in some cases, the aperture 116 is referred to as an exit pupil). Therefore, the beam emitted from the pixel of the parallax corresponding to the direction from the viewpoint of the observer in the element image 141 selectively reaches the viewpoint of the observer. When the beams emitted from the pixels of different parallaxes reach both eyes of the observer, the observer can observe a three-dimensional image.

The display element array 114 that is provided on the rear side of the lenticular sheet as viewed from the observer displays a parallax image group that is slightly differently viewed depending on the angle, i.e., a multi-view image, using the apertures 116 and the element images having a plurality of pixels arranged therein. The emission direction of the beams of the multi-view image is determined by passing through any one of the apertures 116 of the aperture control unit 115. In this way, a three-dimensional image is reproduced.

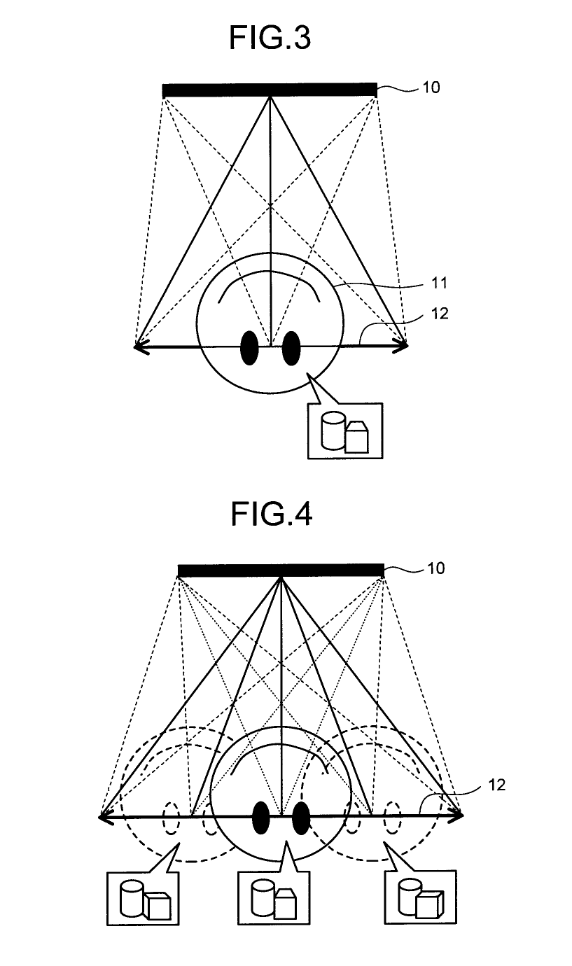

FIG. 3 is a diagram schematically illustrating the relationship among the cross-section of the three-dimensional image display apparatus 10, the sub-pixels, a visual range width 12, which is the range in which a three-dimensional image is observed at a given observation distance (visual distance), and the parallax address in the three-dimensional image display apparatus 10 according to this embodiment. The element image, which is a set of the sub-pixels, has a finite width, and the visual range width 12 in which the parallax image displayed on the sub-pixels is observed also has a finite width. In the example shown in FIG. 3, the number of sub-pixels allocated to one exit pupil, which is the aperture 116 of the aperture control unit 115, that is, the number of viewpoints is 2. The width of the aperture 116, that is, the lens pitch Ps is set to be less than the width of the two sub-pixels allocated to the exit pupil (aperture 116) so that the observer can view a three-dimensional image at a finite distance.

In the example shown in FIG. 4, the number of sub-pixels allocated to one exit pupil (aperture 116), that is, the number of viewpoints is 4. In the example shown in FIG. 4, the lens pitch Ps of the aperture 116 is set to be less than the width of four sub-pixels allocated to the exit pupil (aperture 116). On the contrary, when the lens pitch Ps is equal to the width of four sub-pixels, four sub-pixels, sometimes, five sub-pixels are arranged on the rear side of all of the apertures 116 such that the average value of the width of the sub-pixel is less than the width of the four sub-pixels. In this way, it is possible to widen the visual range at a finite visual distance.

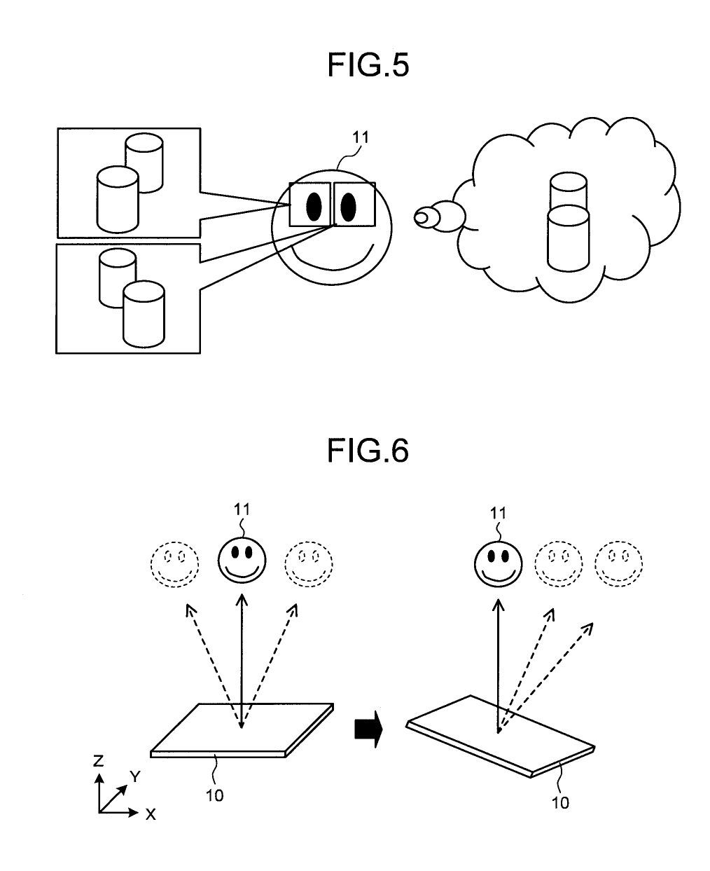

When this embodiment is applied to the glasses-type three-dimensional image display apparatus, as shown in FIG. 5, two parallax images to be viewed by the left and right eyes are temporally alternately displayed in two directions in which polarization or circular polarization directions are orthogonal to each other, and the polarization or circular polarization directions of the displayed parallax images and the polarization or circular polarization directions of polarizing plates provided on the left and right side of the glasses of an observer 11 are aligned with the polarization or circular polarization directions of the parallax images for the left and right eyes. In this way, binocular parallax is given to achieve three-dimensional display.

Next, the relationship between the observation position of the observer relative to the display unit 104 and the display of a three-dimensional image will be described. FIG. 6 is a diagram illustrating the function of the observation position detecting unit 101. When the angle of the three-dimensional image display apparatus 10 is inclined, the position of the observer 11 related to the three-dimensional image display apparatus 10 is changed. The acceleration sensor detects the gravity direction of the three-dimensional image display apparatus 10 and the output of the acceleration sensor is input to the observation position detecting unit 101, thereby indirectly acquiring the observation position of the observer 11 relative to the front surface of the display unit 104. As shown in FIG. 6, for the observation position of the observer, there are the X-Y direction which is parallel to the display surface of the display unit 104 and a distance direction (Z direction) from the display surface, and at least the X direction is acquired. The X direction is vertical to the direction in which the aperture control unit 115 (lenticular sheet) extends.

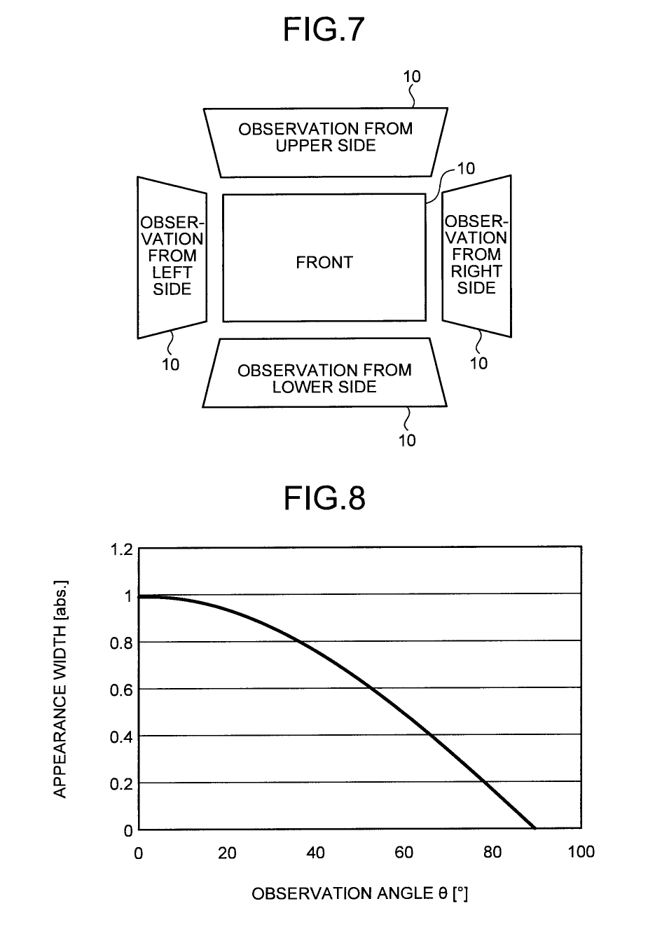

FIG. 7 is a conceptual diagram illustrating a case in which the display surface is recognized to be narrow when the display unit 104 is planar and the three-dimensional image display apparatus is obliquely observed. FIG. 8 is a graph illustrating the relationship between the observation angle θ with respect to the front and the appearance width (or height). When the observer 11 inclines the three-dimensional image display apparatus 10 to the left and right sides from the front side, as shown in FIG. 7, the appearance width is reduced. When the observer 11 inclines the three-dimensional image display apparatus 10 at 90 degrees, the display surface of the display unit 104 cannot be viewed. When the observer 11 inclines the three-dimensional image display apparatus 10 in the vertical direction from the front side, the appearance height is reduced. When the observer 11 inclines the three-dimensional image display apparatus 10 at 90 degrees in the vertical direction, the display surface of the display unit 104 cannot be viewed. That is, as shown in FIG. 8, when the observer 11 inclines the three-dimensional image display apparatus 10 to increase the observation angle θ, the appearance width is reduced, which makes it difficult for the observer to view the display surface.

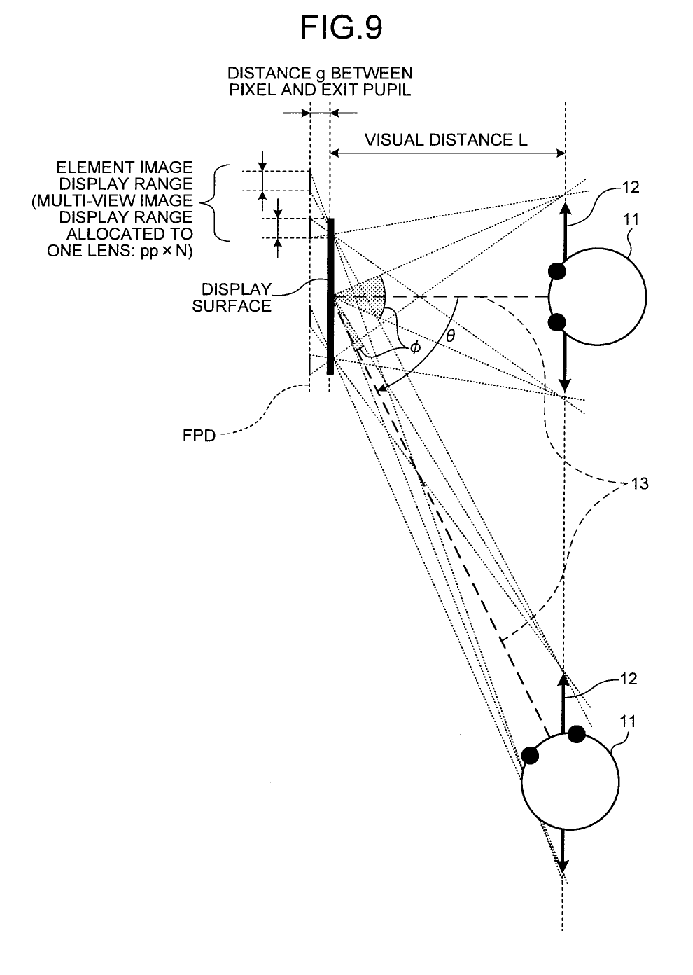

FIG. 9 is a diagram illustrating a case in which, when the observer obliquely views the display surface from the front side, the visual range is reduced even at the same visual range width VW in the three-dimensional image display apparatus 10 according to this embodiment. When the width of the pixel is pp, the number of pixels allocated to one exit pupil is N, the distance from the exit pupil to the pixel is g, and the distance from the display surface of the display unit 104 to the observation position is a visual distance L, the visual range width VW is calculated by the following Expression (1):

VW=(pp×N)×L/g (1)

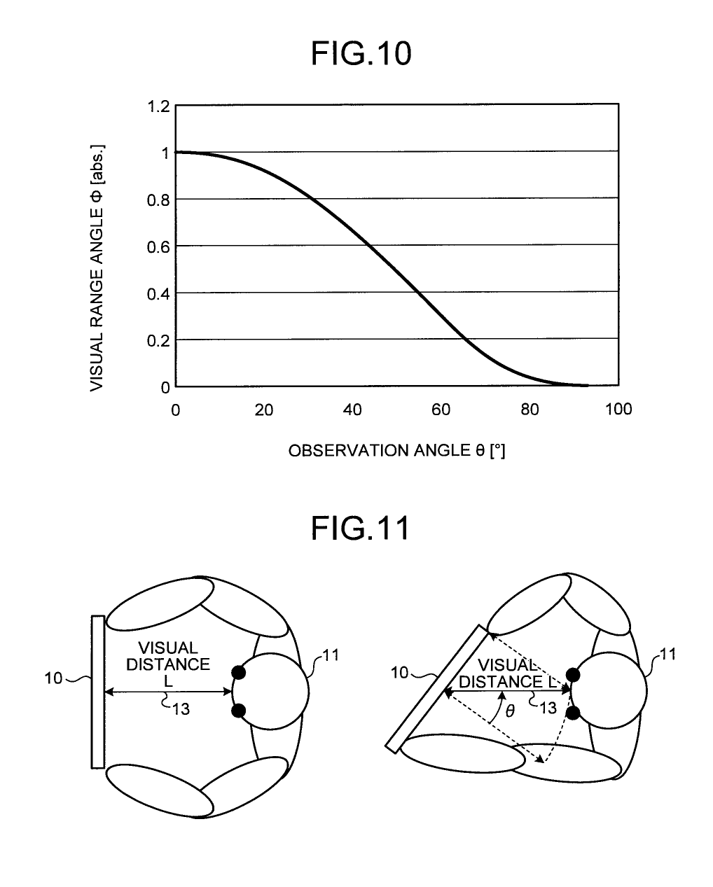

When the visual distance L from the display surface of the display unit 104 to the observation position is constant, the visual range width VW is constant even when N pixels allocated to the exit pupil are changed. In other words, the visual range angle φ shown in FIG. 9 is reduced as the distance from the front surface of the display unit 104 increases. FIG. 10 is a diagram illustrating the dependence of the visual range angle φ on the observation angle θ. As shown in FIG. 10, as the observation angle θ increases, the visual range angle φ is reduced even when the visual range width VW is maintained to be constant. Therefore, it is difficult for both eyes to be within the visual range.

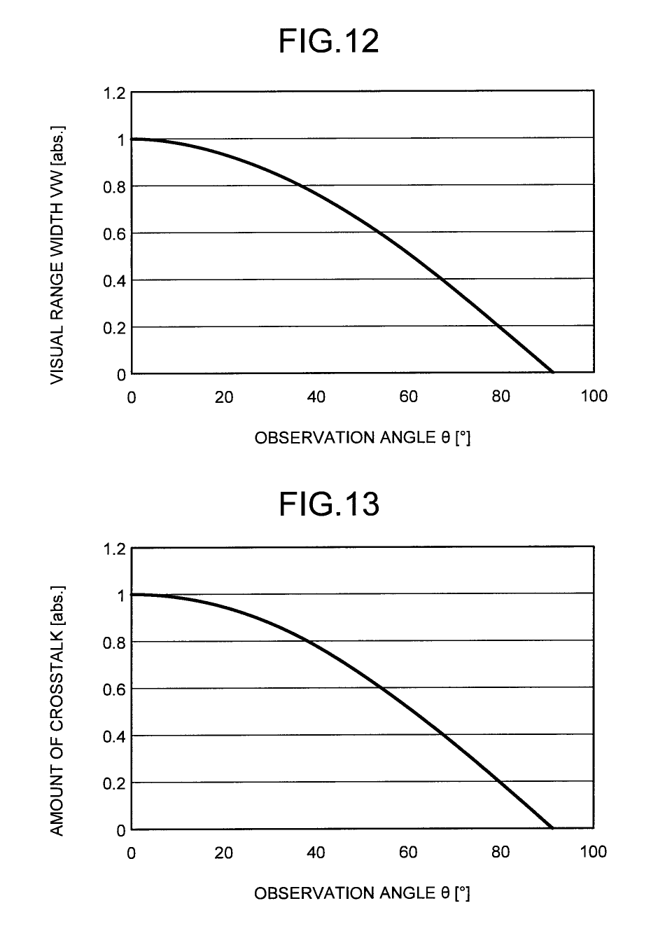

FIG. 11 is a diagram illustrating a case in which the visual distance L is reduced when the observer 11 inclines the three-dimensional image display apparatus 10 by an observation angle θ while holding the three-dimensional image display apparatus 10. Since the visual distance L is proportional to the visual range width VW as shown in Expression (1), the relationship between the observation angle θ from the front side of the display unit 104 and the visual range width VW is as shown in FIG. 12 in which, as the observation angle θ increases, the visual range width VW is reduced. Therefore, when both eyes are not in the visual range, the observer cannot view a correct three-dimensional image.

In this embodiment, the lenticular sheet is used as the aperture control unit 115 serving as a beam controller in the display unit 104. In this case, as shown in FIG. 13, as the observation angle θ with respect to the front surface of the display unit 104 at the observation position increases, the amount of crosstalk attributable to field curvature increases. As a result, the spatial separation of the parallax image is insufficient. The amount of crosstalk means the mixture ratio of parallax images other than the original parallax image to be viewed to the original parallax image.

As described above, as the observation angle θ with respect to the display surface of the display unit 104 increases, the appearance width or height of the display surface is reduced (see FIG. 8), the visual range angle φ is reduced (see FIG. 10), and the amount of crosstalk increases (see FIG. 13). When the observer 11 holds the three-dimensional image display apparatus 10 with the hand, the visual range width VW is reduced as the visual distance L is reduced (see FIG. 12). As a result, it is difficult to represent the depth of a three-dimensional image. In addition, the parallax image to be emitted from an adjacent exit pupil (aperture 116) is inevitably viewed, a row of parallaxes is reversed, and the concavity and convexity of the three-dimensional image are reversely viewed, or an abnormal image, a multi-image in which a plurality of parallax images is superimposed, occurs, which results in a reduction in the quality of a three-dimensional image.

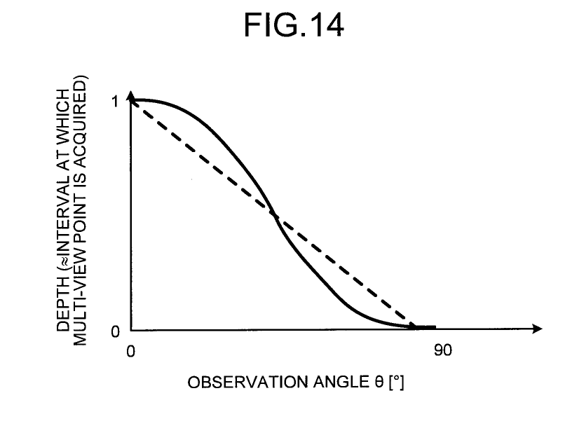

Therefore, in this embodiment, when the observation angle θ with respect to the display surface of the display unit 104 as the observation position of the observer increases, it is determined that a restriction in representing the depth or a reduction in image quality occurs, and the representation of the depth of a three-dimensional image is controlled to maintain the display quality of a three-dimensional image. That is, in order to reduce the depth as the observation angle θ detected by the observation position detecting unit 101 increases, the parallax amount determining unit 102 determines the amount of parallax to be continuously reduced as the observation angle θ increases such that the display image generating unit 103 can use an image with a small amount of parallax as image information to generate an element image array, as shown in FIG. 14.

Specifically, the parallax amount determining unit 102 determines the interval (the gap between viewpoints), at which a multi-view image is acquired, to be continuously reduced as the observation angle θ increases, thereby reducing the amount of parallax. In this way, it is possible to reduce the depth as the observation angle θ increases.

In the example shown in FIG. 14, when the depth observed from the front side of the display unit 104 is 1, the parallax amount determining unit 102 determines the amount of parallax to be continuously reduced as the observation angle θ increases, according to a linear function represented by a dotted line or a non-linear function, such as a cosine function represented by a curved line, thereby reducing the depth.

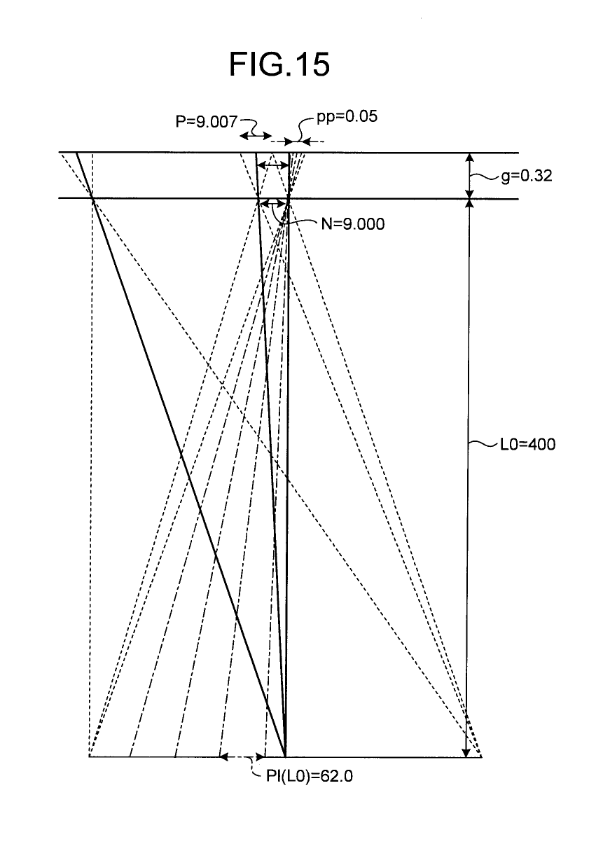

As a method of determining the value of the acquisition interval of the multi-view image which is reduced as the observation angle θ increases using the parallax amount determining unit 102, the following method is used. FIG. 15 is a diagram illustrating the method of determining the acquisition interval of the multi-view image which is reduced as the observation angle θ increases.

When the number of parallaxes is N, an element image pitch is P, the width of the aperture 116, that is, a lens pitch is Ps, a sub-pixel pitch [mm] in the horizontal direction is pp, the distance [mm] between the aperture control unit 115 (lenticular sheet) and the pixel is g, the distance [mm] from the display surface of the display unit 104 is L, a visual range optimization distance is L0, an observation distance is Lv, and the gap [mm] between beams at Pl is Pl (L) [mm], pp, Pl(L), g, L, P, Pe, and L0 are calculated by the following Expressions (2) and (3):

pp:Pl(L)=g:L (2)

P:Ps=(L0+g):L0 (3)

At pp=0.05, when Pl (400)=62 (interocular distance) is established at Lv=400, g is set as represented by the following Expression (4):

0.05:62=g:400,g=0.32 (4)

In order to maximize the visual range width (VW (500)) at L0=500, P and Ps are set so as to satisfy the following Expression (5):

P:Ps=1:(500+0.32)/500=1:1.00064 (5)

In this case, the visual range width VW (L0) and the observation angle θ are calculated by the following Expressions (6) and (7):

VW(L0)=P×L0/g (6)

θ={a tan(VW(L0)right end/L0)−a tan(VW(L0)left end/L0)}/2 (7)

where (VW (L0) right end) and (VW (L0) left end) are the coordinates of both ends of the visual range width VW (L0).

As can be known from the above-mentioned expressions, as the observation angle θ increases, the visual range width VW is reduced. When the interocular distance is 62, the visual range angle φ required for observation is calculated by the following Expression (8):

φ=a tan(62/Lv)/2 (8)

As can be seen from Expression (8), the visual range angle φ depends on the interocular distance and the observation distance. From the above-mentioned expressions, for example, in order to reduce the depth in operative association with the value of (θ−φ), the parallax amount determining unit 102 may determine the acquisition interval of the multi-view image to be a small value, or it may be configured such that a three-dimensional image is obtained when θ>φ and a planar image is obtained when θ≦φ.

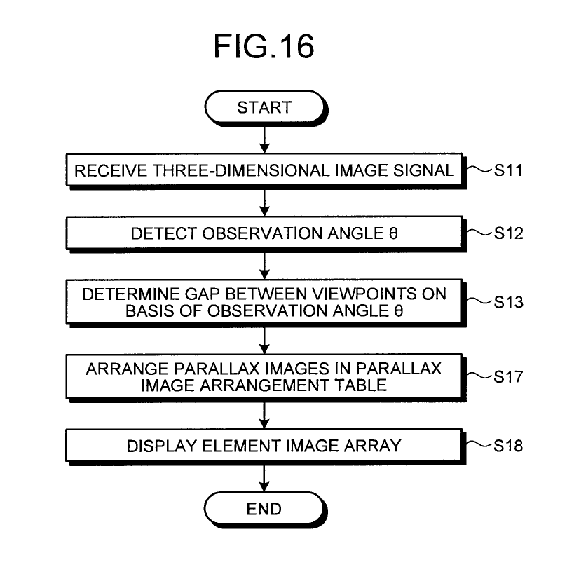

Next, a three-dimensional image display process of this embodiment having the above-mentioned structure will be described with reference to a flowchart shown in FIG. 16.

First, the input unit 105 receives a three-dimensional image signal from an image generating apparatus, such as a camera, or receives the three-dimensional image signal through a decoder of an image reproducing apparatus (Step S11). The observation position detecting unit 101 detects the observation angle θ of the observer with respect to the front surface of the display unit 104 using, for example, the acceleration sensor (Step S12).

Then, the parallax amount determining unit 102 determines the acquisition interval (the gap between viewpoints) at which the multi-view image is acquired on the basis of the observation angle θ detected in Step S12 (Step S13). Specifically, the parallax amount determining unit 102 determines the gap between viewpoints to be reduced as the observation angle θ increases according to the graph shown in FIG. 14 and the method shown in FIG. 15.

The display image generating unit 103 arranges the parallax images in a parallax image arrangement table at the gap between viewpoints determined in Step S13 to generate an element image array (Step S17) and displays the element image array on the display unit 104 (Step S18).

The parallax image arrangement table is an arrangement table indicating the arrangement of the parallax images in each element image of the multi-view image displayed on the display surface of the display unit 104, that is, the element image array, and is described in detail in Japanese Patent No. 3944188.

As described above, in this embodiment, as the observation angle θ increases, the amount of parallax is continuously reduced. In this way, it is possible to correspond to a variation in the width of appearance, the visual range angle φ, the visual range width VW, and the amount of crosstalk which are continuously changed as shown in FIGS. 8, 10, 12, and 13 without incongruity and thus display a high-quality three-dimensional image. That is, when the observation position greatly deviates from the front surface of the display unit 104, the depth is reduced without hindering motion parallax from being ideally given. Therefore, it is possible to prevent the occurrence of an abnormal image and thus display a high-quality three-dimensional image. The reason is that, even when the amount of parallax is reduced, it is possible to separately provide motion parallax and continuously provide a three-dimensional effect in a wide range.

In this embodiment, the three-dimensional image display apparatus receives a three-dimensional image to be displayed from an external image generating apparatus or an image reproducing apparatus and displays the three-dimensional image on the display unit 104 in real time, but the invention is not limited thereto. This embodiment can be applied to a three-dimensional image display apparatus that reads a three-dimensional image stored in a storage medium, such as a hard disk drive (HDD) or a volatile or non-volatile memory, and displays the three-dimensional image on the display unit 104.

### Second Embodiment

In the first embodiment, as the observation angle θ increases, the amount of parallax is continuously reduced. In a second embodiment, when the observation angle θ increases to be more than a threshold value, a display image is rapidly changed to a planar image. Furthermore, in the first embodiment, the three-dimensional image signal is received from, for example, an external image generating apparatus or an image reproducing apparatus and is then displayed on the display unit 104. In the second embodiment, a multi-view image or a single-view image that is stored in an image storage unit 1705 in advance is displayed on the display unit 104.

However, this embodiment may be applied to the three-dimensional image display apparatus that receives a three-dimensional image signal from, for example, an external image generating apparatus or an image reproducing apparatus and displays the three-dimensional image signal on the display unit 104.

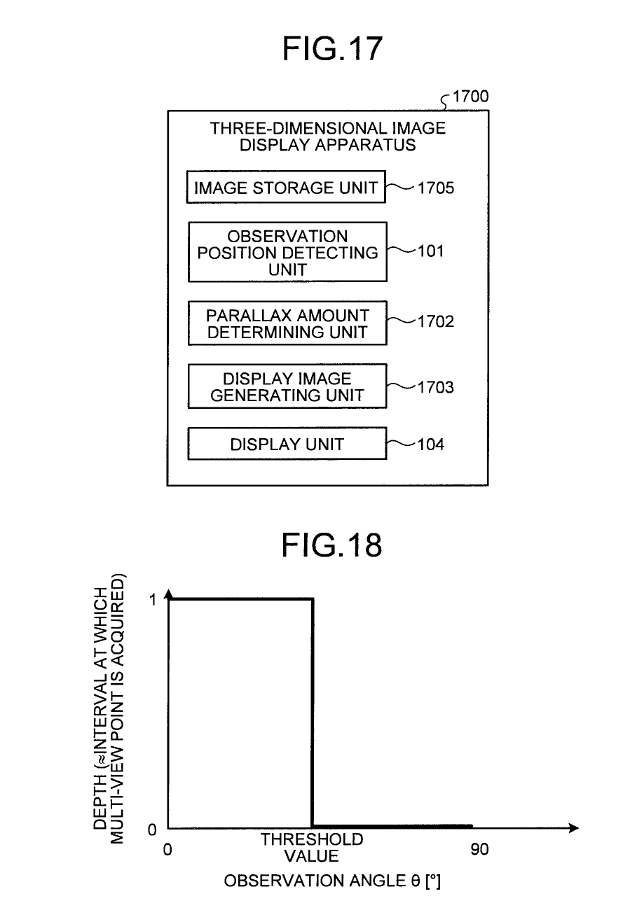

As shown in FIG. 17, a three-dimensional image display apparatus 1700 according to the second embodiment mainly includes the image storage unit 1705, the observation position detecting unit 101, a parallax amount determining unit 1702, a display image generating unit 1703, and the display unit 104. The observation position detecting unit 101 and the display unit 104 have the same function and structure as those in the first embodiment.

The image storage unit 1705 is a storage medium, such as an HDD or a memory that stores therein three-dimensional image signals of a multi-view image or a single-view image in advance.

The parallax amount determining unit 1702 determines whether the observation angle θ detected by the observation position detecting unit 101 is more than a predetermined threshold value. When it is determined that the observation angle θ is more than the threshold value, the parallax amount determining unit 1702 determines the image to have a small amount of parallax. Specifically, as shown in FIG. 18, when it is determined that the observation angle θ is equal to or less than the threshold value, the parallax amount determining unit 1702 does not change the amount of parallax, whereas when it is determined that the observation angle θ is more than the threshold value, the parallax amount determining unit 1702 selects a planar image. In addition, in a case in which the three-dimensional image display apparatus 1700 is applied to an apparatus that receives a three-dimensional image to be displayed from an image generating apparatus, such as a camera, or an image reproducing apparatus and displays the three-dimensional image on the display unit 104 in real time, when the observation angle θ is more than the predetermined threshold value, the parallax amount determining unit 1702 may determine the amount of parallax to be 0. That is, the parallax amount determining unit 1702 may determine the acquisition interval (the gap between viewpoints) at which the multi-view image is acquired to be 0.

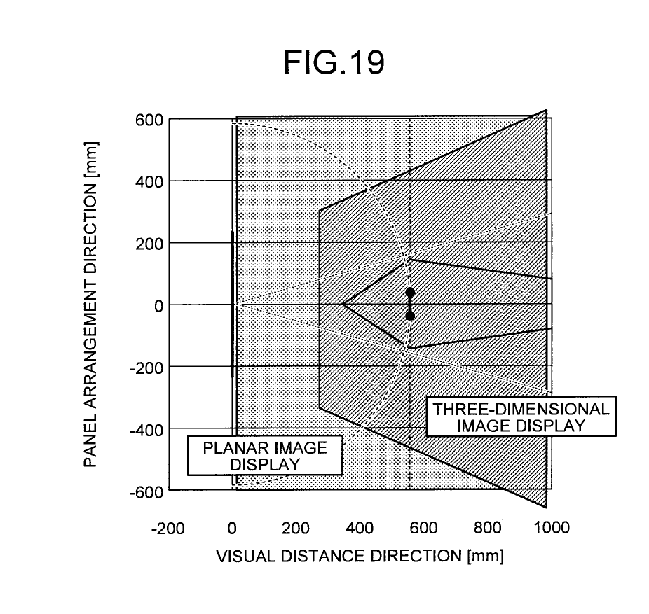

When the threshold value is set in this way, the same three-dimensional image as that on the front side is maintained before both eyes are beyond the visual range or before the amount of crosstalk is more than an allowable value. FIG. 19 shows an example of the division between a planar image display region and a three-dimensional image display region.

In order to prevent the occurrence of an abnormal image when the observation angle θ is more than the threshold value and the image is changed to a planar image, the planar image to be changed may or may not be related to the three-dimensional image display to be displayed. For example, a planar image or an achromatic image, such as a black display (non-display) image that is not related to the three-dimensional image to be displayed, may be selected.

Returning to FIG. 17, similar to the first embodiment, the display image generating unit 1703 generates an element image array and displays the generated element image array on the display unit 104. When the observation angle θ is more than the threshold value, the display image generating unit 1703 selects the planar image determined by the parallax amount determining unit 1702 from the image storage unit 1705 and generates the element image array.

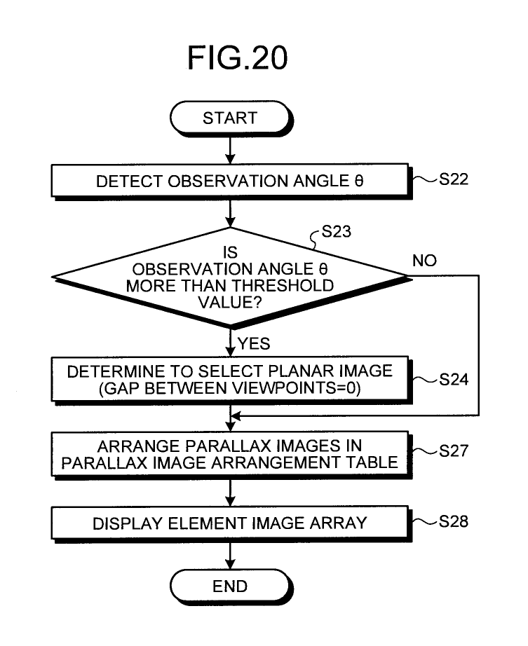

Next, a three-dimensional image display process of this embodiment having the above-mentioned structure will be described with reference to a flowchart shown in FIG. 20.

First, the observation position detecting unit 101 detects the observation angle θ of the observer with respect to the front surface of the display unit 104 using, for example, an acceleration sensor (Step S22).

Then, the parallax amount determining unit 1702 determines whether the observation angle θ detected in Step S22 is more than the threshold value (Step S23). When the observation angle θ is equal to or less than the threshold value (No in Step S23), the parallax amount determining unit 1702 does not change the amount of parallax. When the observation angle θ is more than the threshold value (Yes in Step S23), the parallax amount determining unit 1702 determines to select a planar image (Step S24).

Then, the display image generating unit 1703 acquires the planar image determined in Step S24 from the image storage unit 1705 and arranges it in the parallax image arrangement table to generate an element image array (Step S27). Then, the display image generating unit 1703 displays the element image array on the display unit 104 (Step S28).

As described above, in this embodiment, when the observation angle θ increases to be more than the threshold value, a display image is rapidly changed to a planar image and the planar image is displayed on the display unit 104. Therefore, when the observation position greatly deviates from the front surface, the depth is reduced without hindering motion parallax from being ideally given. Therefore, it is possible to prevent the occurrence of an abnormal image and thus display a high-quality three-dimensional image. Furthermore, it is possible to separately provide motion parallax even in the planar image only when parallax is removed. Therefore, it is possible to continuously provide a small three-dimensional effect.

### First Modification

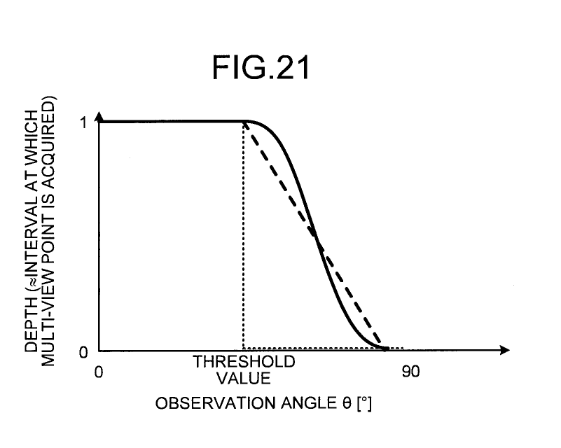

The first embodiment and the second embodiment may be combined to display a three-dimensional image. In a first modification, as shown in FIG. 21, when the observation angle θ detected by the observation position detecting unit 101 is equal to or less than the threshold value, the parallax amount determining unit 102 does not change the amount of parallax, whereas when the observation angle θ is more than the threshold value, the parallax amount determining unit 102 determines the amount of parallax, that is, the gap between the viewpoints of a multi-view image to be continuously reduced, similar to the first embodiment.

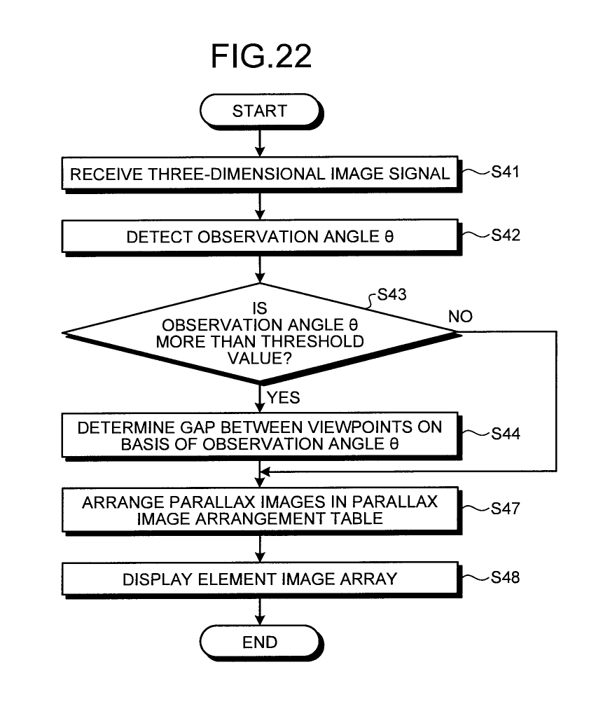

A three-dimensional image display process of the first modification will be described with reference to a flowchart shown in FIG. 22. A step of receiving a three-dimensional image signal and a step of detecting an observation angle θ (Steps S41 and S42) are the same as those in the first embodiment.

Then, the parallax amount determining unit 102 determines whether the observation angle θ detected in Step S42 is more than the threshold value (Step S43). When the observation angle θ is equal to or less than the threshold value (No in Step S43), the parallax amount determining unit 102 does not change the amount of parallax. When the observation angle θ is more than the threshold value (Yes in Step S43), the parallax amount determining unit 102 determines the interval (the gap between viewpoints) at which the multi-view image is acquired on the basis of the observation angle θ detected in Step S42 (Step S44). Specifically, the parallax amount determining unit 102 determines the gap between viewpoints to be reduced as the observation angle θ increases according to the graph shown in FIG. 21.

Then, the display image generating unit 103 arranges parallax images in the parallax image arrangement table at the gap between viewpoints determined in Step S44 to generate an element image array (Step S47), and displays the element image array on the display unit 104 (Step S48).

### Second Modification

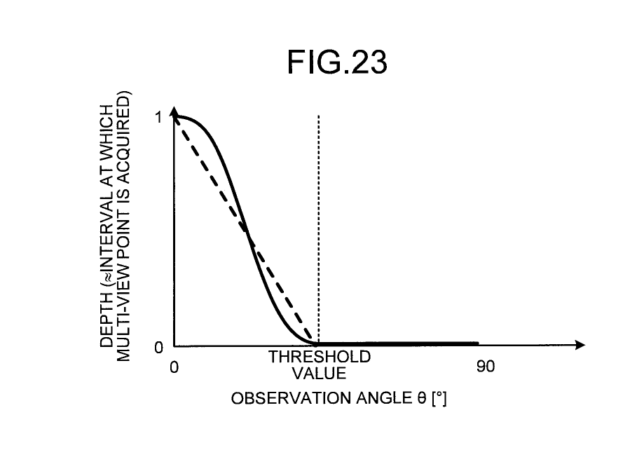

In a second modification, as shown in FIG. 23, when the observation angle θ is equal to or less than the threshold value, the parallax amount determining unit 102 continuously reduces the amount of parallax, that is, the gap between the viewpoints of a multi-view image, similar to the first embodiment. In contrast, when the observation angle θ is more than the threshold value, the parallax amount determining unit 102 selects a planar image.

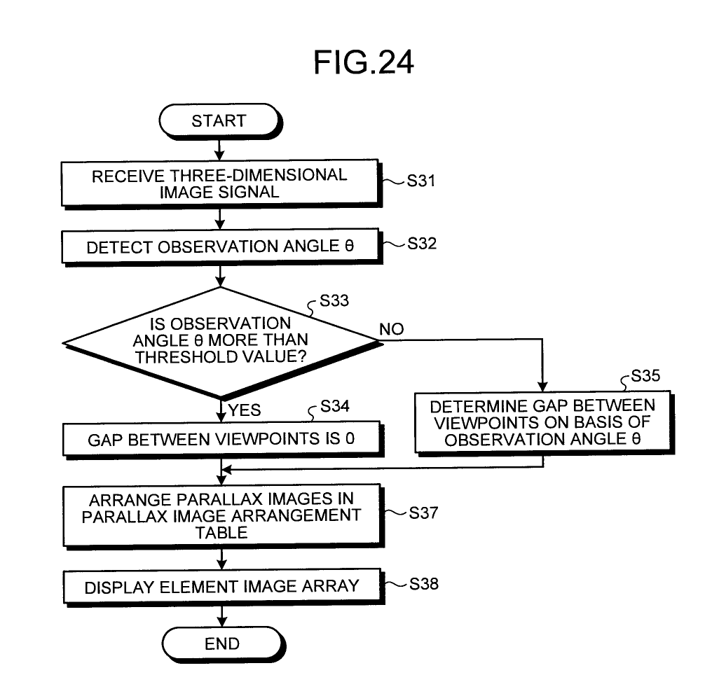

A three-dimensional image display process of the second modification will be described with reference to a flowchart shown in FIG. 24. A step of receiving a three-dimensional image signal and a step of detecting an observation angle θ (Steps S31 and S32) are the same as those in the first embodiment.

Then, the parallax amount determining unit 102 determines whether the observation angle θ detected in Step S32 is more than the threshold value (Step S33). When the observation angle θ is equal to or less than the threshold value (No in Step S33), the parallax amount determining unit 102 determines the interval (the gap between viewpoints) at which the multi-view image is acquired on the basis of the observation angle θ detected in Step S32 (Step S35). Specifically, the parallax amount determining unit 102 determines the gap between viewpoints to be reduced as the observation angle θ increases, according to the graph shown in FIG. 23. In contrast, when the observation angle θ is more than the threshold value (Yes in Step S33), the parallax amount determining unit 102 determines the gap at which the multi-view image is acquired to be 0, that is, the parallax amount determining unit 102 determines to select a planar image, similar to the second embodiment (Step S34).

Then, the display image generating unit 103 arranges parallax images in the parallax image arrangement table at the gap between viewpoints determined in Step S34 to generate an element image array (Step S37), and displays the element image array on the display unit 104 (Step S38).

In the first and second modifications, when the observation position greatly deviates from the front surface, the depth is reduced without hindering motion parallax from being ideally given. Therefore, it is possible to prevent the occurrence of an abnormal image and thus display a high-quality three-dimensional image.

In the above-described embodiments and modifications, when parallax information is given in both the horizontal direction and the vertical direction, it is necessary to apply the three-dimensional image display process to both the horizontal direction and the vertical direction. In this case, a method of reducing depth according to the observation angle θ may be independently performed in the horizontal direction and the vertical direction. In a three-dimensional image display apparatus that provides the parallax information only in the horizontal direction, general tracking may be combined with the vertical direction. In addition, the widening of the visual range by the optimization of N pixels and the switching of the multi-view image according to the embodiments may be performed at the same time.

In the above-described embodiments and modifications, the amount of parallax is reduced on the basis of the observation angle θ with respect to the front surface of the display unit 104 to reduce depth. However, any method may be used as long as it can change the amount of parallax to reduce the depth.

In the three-dimensional image display apparatuses 10 and 1700 according to the embodiments, the structures of the observation position detecting unit 101 and the parallax amount determining unit 102 may be changed in various ways.

For example, in the three-dimensional image display apparatuses 10 and 1700 according to the embodiments, a table indicating the correspondence between the observation angle θ and the observation distance of the observer from the front surface of the display unit 104 shown in FIG. 12 may be stored in a storage medium, such as a memory, in advance. Then, the observation position detecting unit 101 may calculate an observation distance corresponding to the observation angle θ detected by the observation position detecting unit 101 from the correspondence table. In this case, the parallax amount determining unit 102 may determine the amount of parallax on the basis of the observation angle and the observation distance. In this case, the observation distance is considered in addition to the observation angle θ. Therefore, it is possible to accurately calculate the amount of parallax and display a high-quality three-dimensional image.

The three-dimensional image display apparatuses 10 and 1700 according to the embodiments may be provided with an imaging unit such as a camera. In this case, the observation position detecting unit 101 may calculate the size of the head of the observer from the image captured by the imaging unit and calculate the observation distance of the observer from the front surface of the display unit 104 from the calculated size of the head. In addition, the parallax amount determining unit 102 may determine the amount of parallax on the basis of the observation angle θ and the observation distance. In this case, the observation distance is considered in addition to the observation angle θ. Therefore, it is possible to accurately calculate the amount of parallax and display a high-quality three-dimensional image.

A three-dimensional image display program executed by the three-dimensional image display apparatus according to the above-described embodiments is stored in advance into, for example, a ROM and then provided.

The three-dimensional image display program executed by the three-dimensional image display apparatus according to the above-described embodiments may be stored as a file of an installable format or an executable format in a computer-readable storage medium, such as a CD-ROM, a flexible disk (FD), a CD-R, or a DVD (Digital Versatile Disk), and then provided.

The three-dimensional image display program executed by the three-dimensional image display apparatus according to the above-described embodiments may be stored in a computer that is connected to a network, such as the Internet, downloaded from the computer through the network, and then provided. In addition, the three-dimensional image display program executed by the three-dimensional image display apparatus according to the above-described embodiments may be provided or distributed through a network such as the Internet.

The three-dimensional image display program executed by the three-dimensional image display apparatus according to the above-described embodiments may have a module structure including the above-mentioned units (the input unit, the observation position detecting unit, the parallax amount determining unit, and the display image generating unit). As the actual hardware, a CPU (processor) reads the three-dimensional image display program from the ROM and executes the three-dimensional image display program. Then, the above-mentioned units are loaded on the main storage device, and the input unit, the observation position detecting unit, the parallax amount determining unit, and the display image generating unit are generated in the main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A three-dimensional image display apparatus comprising:
a display unit;
a detecting unit configured to detect an observation position of an observer relative to the display unit;
a determining unit configured to determine an amount of parallax of an input image signal to be reduced as an angle increases between a normal direction of a surface of the display unit and an observation direction based on the detected observation position or as a distance decreases between the surface of the display unit and the detected observation position; and
a generating unit configured to generate a multi-view image to be displayed on the display unit on a basis of the determined amount of parallax.

2. The apparatus according to claim 1, wherein
the determining unit determines the amount of parallax to be continuously reduced as the angle increases between the normal direction of the surface of the display unit and the observation direction or as the distance decreases between the surface of the display unit and the detected observation position.

3. The apparatus according to claim 2, wherein
the determining unit determines the amount of parallax to be continuously reduced according to a linear function.

4. The apparatus according to claim 2, wherein
the determining unit determines the amount of parallax to be continuously reduced according to a cosine function.

5. The apparatus according to claim 1, wherein
the determining unit determines whether the detected observation position is more than a predetermined threshold value, and when the detected observation position is more than the threshold value, the determining unit determines the amount of parallax to be reduced.

6. The apparatus according to claim 5, wherein
when the detected observation position is equal to or less than the threshold value, the determining unit determines the amount of parallax to be continuously reduced.

7. The apparatus according to claim 5, wherein
when the detected observation position is more than the threshold value, the determining unit determines the amount of parallax to be 0.

8. The apparatus according to claim 7, wherein
when the detected observation position is more than the threshold value, the determining unit determines a display image to be a planar image that is not related to the input image signal.

9. The apparatus according to claim 8, wherein
the planar image that is not related to the input image signal is an achromatic image.

10. The apparatus according to claim 5, wherein,
when the detected observation position is equal to or less than the threshold value, the determining unit does not change the amount of parallax, and
when the detected observation position is more than the threshold value, the determining unit continuously reduces the amount of parallax.

11. The apparatus according to claim 1, wherein
the determining unit determines the amount of parallax such that an interval at which the multi-view image is acquired is reduced as the angle increases between the normal direction of the surface of the display unit and the observation direction or as the distance decreases between the surface of the display unit and the detected observation position.

12. The apparatus according to claim 1, wherein
the detecting unit detects, as the observation position, the observation angle of the observer with respect to the surface of the display unit from an output of an acceleration sensor, the acceleration sensor being worn by the observer and detecting the observation direction.

13. The apparatus according to claim 12, further comprising a storage unit configured to store therein a correspondence between the observation angle and an observation distance between the observation position of the observer and the surface of the display unit in advance, wherein
the detecting unit acquires the observation distance corresponding to the detected observation angle from the correspondence, and
the determining unit determines the amount of parallax on the basis of the observation angle and the observation distance.

14. The apparatus according to claim 12, further comprising a head tracking sensor, wherein
the detecting unit detects, as the observation position, the observation angle of the observer with respect to the surface of the display unit from outputs of the acceleration sensor and the head tracking sensor.

15. The apparatus according to claim 14, further comprising an imaging unit, wherein
the detecting unit calculates a size of a head of the observer from an image captured by the imaging unit and calculates the observation distance between the observer and the surface of the display unit on the basis of the size of the head, and
the determining unit determines the amount of parallax on the basis of the observation angle and the observation distance.

16. A three-dimensional image processor comprising:
a determining unit configured to determine an amount of parallax of an input image signal to be reduced as an angle increases between a normal direction of a surface of a display unit and an observation direction based on a observation position of an observer relative to the display unit or as a distance decreases between the surface of the display unit and the observation position; and
a generating unit configured to generate a multi-view image to be displayed on the display unit on a basis of the determined amount of parallax.

17. A three-dimensional image display method performed by a three-dimensional image display apparatus including a display unit, comprising:
detecting an observation position of an observer relative to the display unit;
determining an amount of parallax of an input image signal to be reduced as an angle increases between a normal direction of a surface of the display unit and an observation direction based on the observation position or as a distance decreases between the surface of the display unit and the observation position; and
generating a multi-view image to be displayed on the display unit on a basis of the determined amount of parallax.

18. A computer program product comprising a computer-readable medium including programmed instructions, wherein the instructions, when executed by a computer including a display unit, cause the computer to perform:
detecting an observation position of an observer relative to the display unit;
determining an amount of parallax of an input image signal to be reduced as an angle increases between a normal direction of a surface of the display unit and an observation direction based on the observation position or as a distance decreases between the surface of the display unit and the observation position; and
generating a multi-view image to be displayed on the display unit on a basis of the determined amount of parallax.
